(19) United States
(12) Patent Application Publication
(10) Pub. No.: US 2008/0083793 A1
(43) Pub. Date: Apr. 10, 2008

(54) Chemical distribution device

(76) Inventor: Larry Swain, Henderson, NV (US)

Correspondence Address: ROBERT RYAN MORISHITA;MORISHITA LAW FIRM, LLC, 3800 HOWARD HUGHES PKWY,, SUITE 850, LAS VEGAS, NV, 89169, US

(21) Appl. No.: 11/543,614

(22) Filed: Oct. 5, 2006

(51) Int. Cl. B67D 5/08

(52) U.S. Cl. 222/638

(57) ABSTRACT

A device for delivering a chemical to an area includes a chemical supply tank and, optionally, a solvent supply line. The device includes a controller that delivers the chemicals, or a mixture of the chemicals and solvent, and actuates flow of the chemicals or chemical-solvent mixture from the controller. Optionally, the actuator includes a timer in combination with a pump and/or control valve. The chemicals or chemical-solvent mixture is delivered to a feed line, optionally through a filter and flow controller, to a dispenser.

### FIELD OF THE INVENTION

The present invention relates to devices for the distribution of chemicals. More specifically, the present invention is a device to allow the user to control the spraying of insecticides and pesticides around a building structure.

### BACKGROUND OF THE INVENTION

Pest control has become a burgeoning industry in many areas of the United States. As sections of the country, particularly those in the Sun Belt States, experience substantial rates of growth and as the segment of the populace owning or renting a home rather than an apartment mushrooms, it is becoming increasingly necessary to provide pest control products and services to the resident of single family dwellings.

The pest control industry today is largely populated with service companies and single application home products, so that the homeowner has only two alternatives. They can hire a company to spray on a scheduled basis, or they can manually perform the same action on the same schedule. In fact, the application of pesticides, insecticides, and even herbicides, remains essentially a manual operation in all but the largest of commercial settings.

On the other hand, the automation of home irrigation systems has been dramatic. In many areas, the majority of new home construction includes either an underground drip system, or the connections necessary to install such a system at the owner's discretion. Such systems are designed for simple and effective configuration to allow users to define the schedule and duration of irrigation to be applied, and to easily change such programming as the seasons change, or as requirements or restrictions vary. Such systems, however, are generally not designed for the application of materials with the caustic and generally poisonous characteristics of pesticides, insecticides, and herbicides.

There is therefore a need in the industry to develop an automatic distribution system for the programmatic scheduled application of chemicals of a caustic and noxious nature, such as might reasonably be expected with a pesticide or similar compound.

### SUMMARY OF THE INVENTION

A device for mixing and dispensing of chemicals in solution or suspension in an area surrounding a building structure includes at least one chemical supply tank containing the chemicals to be dispensed. In an optional embodiment, the chemicals are pesticides, herbicides, and/or fungicides. Optionally, the device also includes a solvent supply line. Optionally, the solvent supply line is a water line and the solvent is water.

The device includes a controller. The controller has a manifold in communication with the chemical supply tank. The manifold delivers the chemical from the chemical supply tank to an outlet.

In an optional embodiment, the device includes a solvent supply line. In such an optional embodiment, the manifold is connected to the solvent supply line and the chemical supply line and mixes solvent from the solvent supply line with chemicals from the chemical supply tank. An outlet communicates with the manifold and carries the mixture of the solvent and the chemicals from the manifold.

The controller includes an actuator that selectively permits and restricts flow of the chemicals, or in an optional embodiment a solvent-chemical mixture, from the outlet. In one optional embodiment, the actuator includes a timer communicating with a power source. In such an optional embodiment, the timer generates a timing signal that prompts the actuator to permit or restrict flow of the mixture through the outlet. In an optional embodiment, the actuator may include a pump that is selectively operated by the timer based on the timing signal. In another optional embodiment, the actuator may include a control valve that is selectively operated by the timer based on the timing signal.

A feed line communicates with the outlet. The feed line receives the chemicals or solvent-chemical mixture from the outlet. Optionally, the feed line includes a filter and a flow controller to restrict flow through the flow line from flowing back toward the controller.

A dispenser receives the chemicals or solvent-chemical mixture either directly, or through an intermediate dispensing line, from the feed line. The dispenser delivers the chemicals or mixture of the solvent and the chemicals to the area. The dispenser could take many different forms, including a nozzle, atomizer, spray fixture, stream fixture, or drip fixture. In one optional embodiment, the area to be treated includes ground surrounding the building structure and the dispenser is substantially at ground level. In an additional or alternative embodiment, the area to be treated includes walls surrounding the building structure and the dispenser is mounted to the walls.

### BRIEF DESCRIPTION OF THE DRAWINGS

FIG. 1 is a schematic illustration of an installation of an embodiment of the present invention;

FIG. 2 is an illustration of an embodiment of a dispenser nozzle of the present invention; and

FIG. 3 is an illustration of an embodiment of a control housing of the present invention.

### DESCRIPTION

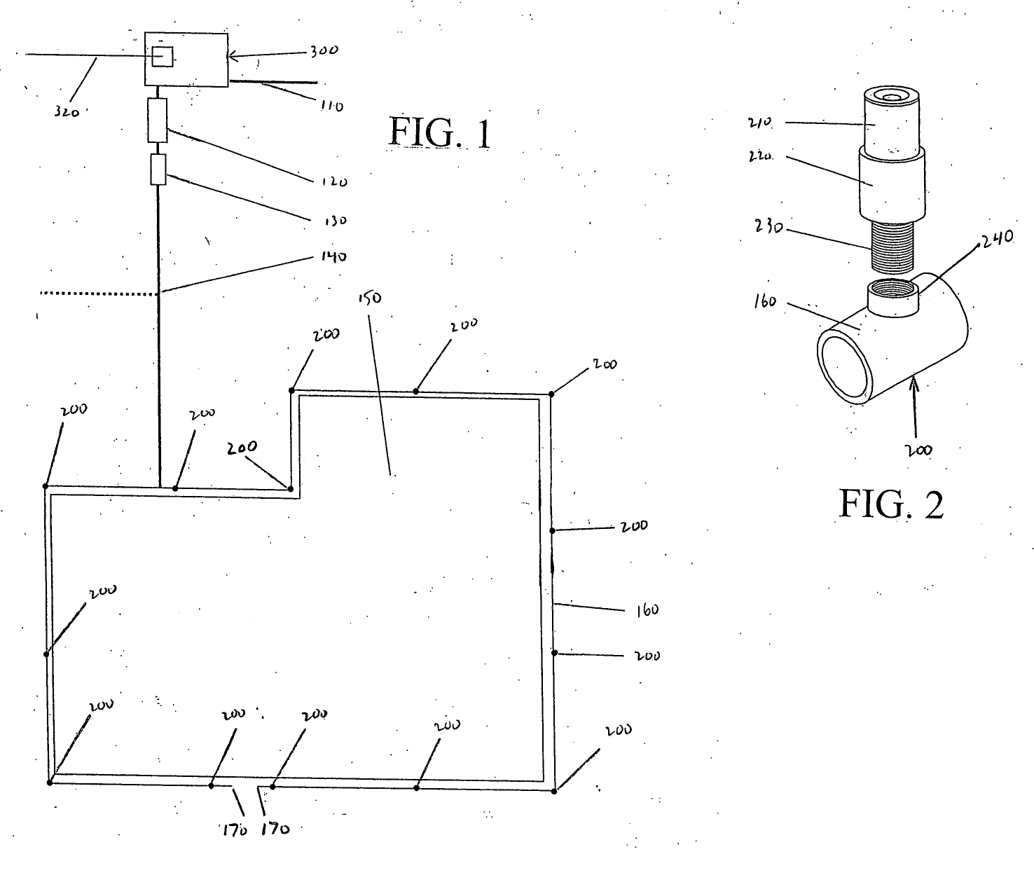

Reference is now made to the figures wherein like parts are referred to by like numerals throughout. Referring generally to FIGS. 1-3, an optional embodiment of a chemical distribution device is shown. In the optional embodiment of the figures, the chemical distribution device includes a solvent supply line 110 that delivers solvent to a manifold 370 in a controller 300. The manifold 370 communicates with at least one chemical supply tank 380 and mixes solvent from the solvent supply line with chemicals from the chemical supply tank 380. The mixture is delivered from the manifold 370 to a feed line 140 through an outlet 340 under the control of an actuator (described in greater detail below). The mixture is delivered to the area by one or more dispensers 200 that receive the mixture from the feed line 140 either directly or through an intermediate distribution line 160.

In an optional embodiment, it is contemplated that the solvent may be water, and the solvent supply line 110 may be a water line connected to the water supply of the building structure 150. However, it is contemplated that alternate solvents may be employed. For example, if the chemical or chemicals dispensed are not water soluble, a different solvent may be used.

In an optional embodiment, it is contemplated that one or more chemicals may be stored in one or more chemical supply tanks 380. Optionally, the chemicals are pesticides, herbicides, fungicides, or like pest control chemicals. It is noted that in one optional embodiment, the chemical(s) may be dispensed directly from the chemical supply tanks 380 to the manifold 370 without first diluting the chemical(s) with solvent. In such an optional embodiment, rather than delivering the chemical(s) to the outlet 340 under the control of an actuator (described in greater detail below). The chemical(s) are delivered to the area by one or more dispensers 200 that receive the chemical(s) from the feed line 140 either directly or through an intermediate distribution line 160.

Shown in detail in FIG. 2, in the optional embodiment illustrated, the controller 300 may include a power source 320, a backup power supply 330, a timer 310, and an actuator (described in greater detail below). In the optional embodiment illustrated, the components of the controller 300 are housed together in a single control box; in alternate optional embodiments, the components of the controller 300 may be differently grouped and housed in one or more control boxes.

In the optional embodiment illustrated, the power source 320 may be provided by standard household electrical supply. In alternate optional embodiments, alternative power supplies may be used, such as wind or water power, power generation, solar power, or the like.

In the optional embodiment illustrated, the timer 310 receives power from the power source 320 or, in the event of failure of the power source 320, a backup power supply 330. It is noted that a circuit that switches between the power source 320 and the backup power supply 330 could include a conventional voltage or current sensor determining whether electrical power is flowing from the power source 320 and a conventional switch switching to the backup power supply 330 if no electrical power is sensed. It is noted that while the optional embodiment illustrated includes a backup power supply 330, this component is optional and may be eliminated without changing the design of the invention.

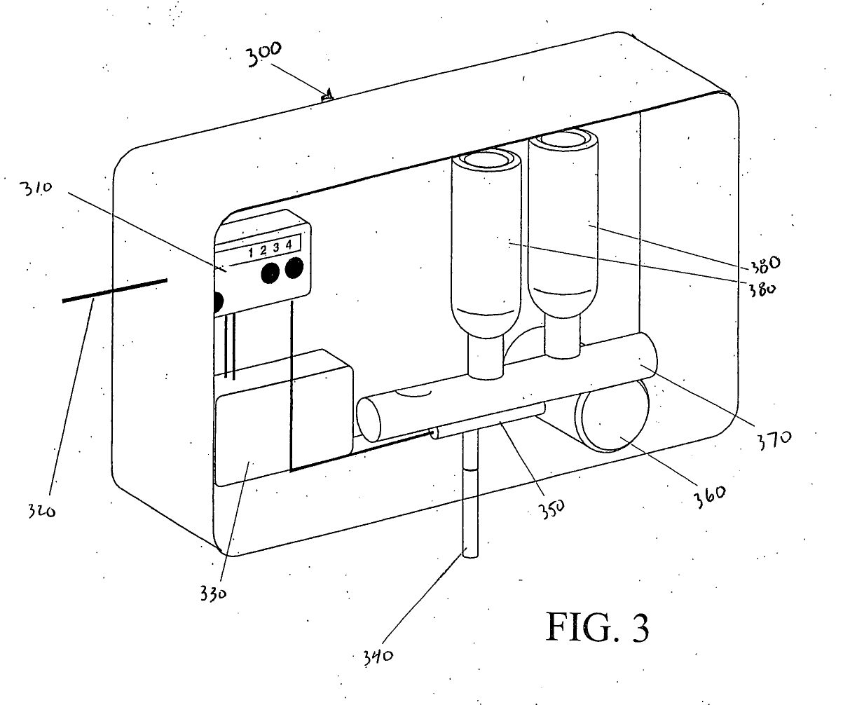

The timer 310 generates a timing signal that is received by an actuator to selectively activate or deactivate the flow of the mixture through the outlet. The actuator may take many different forms. For example, the actuator may include a pump 350 that is selectively activated based on the timing signal. In another example, the actuator may include a control valve 360 that is selectively opened based on the timing signal. In the optional embodiment of FIG. 3, the actuator includes both a pump 350 and a control valve 360.

Whether the actuator includes a pump 350, control valve 360, or other device for selectively controlling flow, it is noted that the actuator may communicate with at least one of the solvent supply line (in an embodiment that includes a solvent supply line), the chemical supply tank, and the manifold. That is, in one optional embodiment, the actuator may communicate with only the solvent supply line and control the flow through the controller by selectively permitting or restricting flow of the solvent into the manifold. In another optional embodiment, the actuator may communicate with only the chemical supply tank and control flow through the controller by selectively permitting or restricting flow of the chemical(s) into the manifold. In another optional embodiment, the actuator may communicate with both the solvent supply line and the chemical supply tank to control flow through the controller by selectively permitting or restricting flow of both the solvent and chemical(s) into the manifold. In yet another optional embodiment, the actuator may communicate with the manifold and control flow through the controller by selectively permitting or restricting flow of the mixture of solvent and chemical from the manifold.

In the optional embodiment of FIG. 3, a control valve 350 resides between the manifold 370 and the outlet 340 to control flow of the mixture from the manifold and a pump 360 communicates with the solvent supply line to selectively control flow of the solvent into the manifold. In the optional embodiment illustrated, the timer 310 communicates with both the valve 350 and the pump 360 to close the valve 350 and/or deactivate the pump 360 when no chemical is to be dispensed. It is noted that in an optional embodiment, solvent flow may be continuous, and the dispensing of chemical may be controlled by the timer 310 strictly through the valve 350.

Returning to FIG. 3, in the optional embodiment illustrated, when the timer 310 signals the pump 360 to do so, solvent is pumped into the manifold 370 where it is mixed with chemicals from the chemical supply tank(s) 380 to form the mixture of chemical(s) and solvent. It is noted that the mixture may take many forms, including a suspension, a solution, or the like. This mixture then passes out of the controller 300 through the outlet 340.

Returning to FIG. 1, in the optional embodiment illustrated the mixture is carried through the outlet 340 and into a feed line 140. In an optional embodiment, the feed line 140 carries the mixture through a filter 120 to remove impurities and a flow controller 130, such as a backflow prevention device, to prevent backwash of the mixture into the controller 300. This feed line 140 continues to carry the mixture to one or more dispensers 200. Optionally, the mixture passes through one or more dispensing lines 160 before reaching the dispenser 200.

In the optional embodiment illustrated, the dispensing line 160 delivers the mixture around the building structure 150 and the area where the mixture is to be dispensed. It is noted that in an optional embodiment, the feed line 140 and dispensing line 160 are above-ground. However, it is noted that the feed line 140 and dispensing line 160 could, in alternate optional embodiments, be buried below ground level. In either case, the dispensers 200 could be disposed substantially at ground level or may extend upwards from the ground. In one optional embodiment, in which the area includes the walls of the building structure, the dispensers 200 may be attached to the walls. Thus, in alternate optional embodiments, the mixture may be delivered to the ground, to the walls of the building structure, or to an area above the ground.

In the optional embodiment illustrated in FIGS. 1 and 2, the feed line 140 carries the mixture to the dispensing line 160, and the dispensing line 160 extends to surround the building structure 150. In an alternate optional embodiment, the dispensing line 160 may form a closed loop, i.e. series circuit, or ladder loop, i.e. parallel circuit, without changing the spirit of the invention.

Arranged along the dispensing line are at least one dispenser 200 for the delivery of the dispensed fluid. As shown in FIG. 2, in the optional embodiment illustrated, the dispenser 200 is connected in-line with the dispensing line 160. In alternate optional embodiments, different connection configurations may be employed without changing the spirit of the invention. As illustrated herein, the mixture is delivered to the dispenser 200 by the dispensing line 160 through a T-connection 240. The mixture flows through the T-connection 240, to the dispenser nozzle housing 220 which is attached to the T-connection with a threaded connection 230. Once the mixture passes through the dispenser nozzle housing 220, it proceeds to a dispenser head 210 that includes a nozzle, sprayer, dripper, or other delivery opening that dispenses and disperses the mixture to the area.

In an optional embodiment in which the chemical(s) are pesticides, the lines, pipes, connections, and dispensers may be formed from a polymer, such as polyvinyl chloride (“PVC”), to contain the chemical(s) and mixture in a fluid-tight manner unlikely to corrode.

While certain embodiments of the present invention have been shown and described it is to be understood that the present invention is subject to many modifications and changes without departing from the spirit and scope of the claims presented herein.

I claim:

1. A device for mixing and dispensing of one or more chemicals in solution or suspension in an area surrounding a building structure, comprising:
at least one chemical supply tank containing said chemical to be dispensed;
a controller comprising:
a manifold in communication with said chemical supply tank, said manifold delivering said chemical from said chemical supply tank;
an outlet in communication with said manifold carrying said chemical from said manifold; and
an actuator adapted to selectively permit and restrict flow of said chemical from said outlet; and
a feed line in communication with said outlet adapted to receive said chemical from said outlet;
a dispenser in communication with said feed line adapted to receive said chemical from said feed line and deliver said chemical to said area.

2. The device of claim 1 wherein said actuator comprises a pump in communication with at least one of said chemical supply tank and said manifold, said pump adapted to selectively deliver said chemical through said controller.

3. The device of claim 1 wherein said actuator comprises:
a power source;
a timer in communication with said power source, said timer adapted to generate a timing signal; and
a pump in communication with at least one of said chemical supply tank and said manifold, said pump receiving power from said power source and receiving said timing signal from said timer to selectively operate said pump to deliver said chemical through said controller.

4. The device of claim 1 wherein said actuator comprises a control valve in communication with at least one of said chemical supply tank and said manifold, said control valve adapted to selectively permit and restrict flow of said chemical through said controller.

5. The device of claim 1 wherein said actuator further comprises:
a power source;
a timer in communication with said power source, said timer adapted to generate a timing signal; and
a control valve in communication with said chemical supply tank, said control valve receiving power from said power source and receiving said timing signal from said timer to selectively permit and restrict flow of said chemical through said controller.

6. The device of claim 1 wherein said chemical is a pesticide.

7. The device of claim 1 further comprising a solvent supply line in communication with said manifold, wherein said manifold is adapted to mix solvent received from said solvent supply line with chemical received from said chemical supply tank and deliver said mixture of said solvent and said chemical to said outlet.

8. The device of claim 1 wherein said feed line further comprises:
a filter; and
a flow controller oriented to prevent flow toward said controller.

9. The device of claim 1 wherein said area includes ground proximate said building structure and said dispenser is substantially level with said ground.

10. The device of claim 1 wherein said area includes walls forming said building structure and said dispenser is mounted to said walls.

11. A device for mixing and dispensing of chemical in solution or suspension in an area surrounding a building structure, comprising:
a solvent supply line;
at least one chemical supply tank containing said chemical to be dispensed;
a controller comprising:
a power source;
a manifold in communication with said solvent supply line and said chemical supply tank, said manifold mixing solvent from said solvent supply line with chemical from said chemical supply tank;
an outlet in communication with said manifold carrying said mixture of said solvent and said chemical from said manifold; and
an actuator in communication with said power source, said actuator adapted to selectively permit and restrict flow of said mixture of said solvent and said chemical from said outlet; and
a feed line in communication with said outlet adapted to receive said mixture of said solvent and said chemical from said outlet;
at least one dispensing line in communication with said feed line;
at least one dispenser in communication with said dispensing line adapted to receive said mixture of said solvent and said chemical from said dispensing line and deliver said mixture of said solvent and said chemical to said area.

12. The device of claim 11 wherein said actuator further comprises a timer in communication with said power source, said timer adapted to generate a timing signal, said actuator adapted to selectively permit and restrict flow of said mixture upon generation of said timing signal.

13. The device of claim 12 wherein said actuator further comprises a pump in communication with at least one of said solvent supply line, said chemical supply tank, and said manifold, said pump receiving power from said power source and receiving said timing signal from said timer to selectively operate said pump to deliver at least one of said solvent, said chemical, and said mixture of said solvent and said chemical through said controller.

14. The device of claim 12 wherein said actuator further comprises a control valve in communication with at least one of said solvent supply line and said chemical supply tank, said control valve receiving power from said power source and receiving said timing signal from said timer to selectively permit and restrict flow of at least one of said solvent, said chemical, and said mixture of said solvent and said chemical through said controller.

15. The device of claim 11 wherein said chemical is a pesticide.

16. The device of claim 11 wherein said solvent is water.

17. The device of claim 11 wherein said feed line further comprises:
a filter; and
a flow controller oriented to prevent flow toward said controller.

18. The device of claim 11 wherein said area includes ground proximate said building structure and said dispenser is substantially level with said ground.

19. The device of claim 11 wherein said area includes walls forming said building structure and said dispenser is mounted to said walls.
